(19) United States
(12) Patent Application Publication
(10) Pub. No.: US 2021/0268956 A1
(43) Pub. Date: Sep. 2, 2021

(54) INDICATION SYSTEM FOR VEHICLES AND ASSOCIATED METHODS

(71) Applicant: Jiaxing Rodrock Auto Parts Manufacturing Company Limited, Jiaxing (CN)

(72) Inventor: Xiangming Guo, Jiaxing (CN)

(21) Appl. No.: 16/806,221

(22) Filed: Mar. 2, 2020

(51) Int. Cl. B60Q 1/34; F21S 43/14; H05B 45/325; H05B 47/175; B60Q 1/30; B60Q 1/44

(52) U.S. Cl. CPC B60Q 1/34; F21S 43/14; H05B 45/325; F21W 2107/10; B60Q 1/305; B60Q 1/44; H05B 47/175

(57) ABSTRACT

Examples of the various techniques introduced here include, but not limited to, a method for generating a visual indication. The method includes receiving a signal indicative of an event associated with a vehicle operation and instructing a lighting device to emit light rays based at least in part on the signal. The method further includes instructing a constant-current module to provide a constant current to the lighting device when emitting the light rays.

### TECHNICAL FIELD

The present disclosure is directed to systems and methods for generating visual signals. More particularly, the present system can be installed in a vehicle and configured to provide visual indications based on signals from the vehicle.

### BACKGROUND

Visual indications, such as turn signals, is important for vehicle safety. For example, turn signals are used to show directions in which vehicles are or will be turning. For certain vehicles, such as towing trucks, cargo trucks, tractors, caravans, trailers, etc., drivers may not always have unobstructed views around these vehicles when operating them, and accordingly providing a sufficient visual indication for others on the road for such types of vehicles can be more critical than other types of vehicles. As a result, it is advantages and desirable to have an improved visual indication system to address the foregoing needs.

### BRIEF DESCRIPTION OF THE DRAWINGS

One or more embodiments of the present disclosure are illustrated by way of example and not limitation in the figures of the accompanying drawings, in which like references indicate similar elements. These drawings are not necessarily drawn to scale.

FIG. 1 is a schematic diagram illustrating a system in accordance with an embodiment of the present disclosure.

FIG. 2A is a schematic diagram illustrating a transmitter (TX) and two receivers (RX) in accordance with an embodiment of the present disclosure.

FIG. 2B is a schematic diagram illustrating a transmitter and two receivers in accordance with an embodiment of the present disclosure.

FIG. 2C is a schematic diagram illustrating a transmitter and multiple receivers in accordance with an embodiment of the present disclosure.

FIG. 3 is a schematic diagram illustrating a system configuration on a vehicle in accordance with an embodiment of the present disclosure.

FIG. 4 is a schematic diagram illustrating a transmitter in accordance with an embodiment of the present disclosure.

FIG. 5 is a schematic diagram illustrating a receiver in accordance with an embodiment of the present disclosure.

FIG. 6 is an isometric view of a receiver in accordance with an embodiment of the present disclosure.

FIG. 7 is a partially-exploded, isometric view of a receiver in accordance with an embodiment of the present disclosure.

FIG. 8 is an image showing a receiver in accordance with an embodiment of the present disclosure.

FIG. 9 is a flowchart showing a method in accordance with an embodiment of the present disclosure.

### DETAILED DESCRIPTION

The present disclosure is directed to a system for providing a visual indication to viewers in proximity of a vehicle. The system can be installed, attached, or positioned on the vehicle. In some embodiments, the system includes a transmitter (TX) and one or more receivers (RX). The transmitter is communicably coupled to a processor or a controller of the vehicle. The one or more receivers are positioned or attached to particular locations (e.g., the rear or the sides) of the vehicle. The transmitter is configured to receive signals regarding the vehicle (e.g., moving or turning directions, a status of the vehicle, etc.) from the controller. The transmitter then transmits the received signals to the one or more receivers via a wireless or wired communication. After receiving the transmitted signals, the receivers can analyze the signals and then generate visual indications based on the transmitted signals.

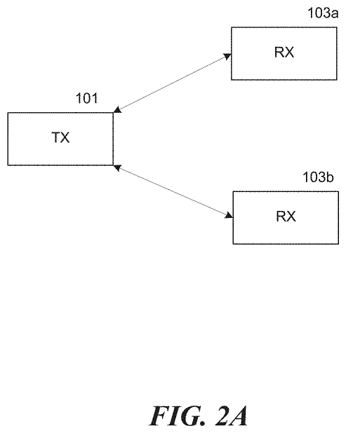

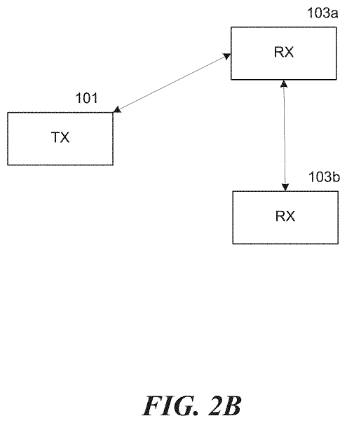

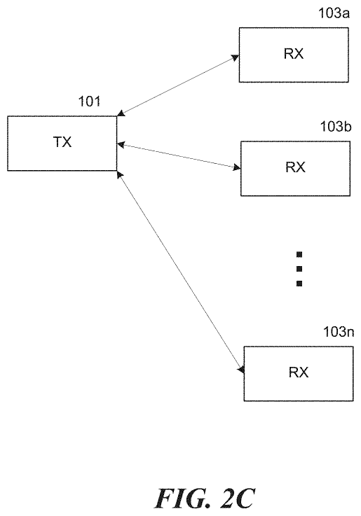

In some embodiments, the present system can include two receivers, a passenger-side receiver and a driver-side receiver. The passenger-side receiver can be positioned at a side of a vehicle where a passenger is located (the “passenger side”), and the driver-side receiver can be positioned at a side of the vehicle where a driver is located (the “driver side”). A transmitter can be coupled to a signal interface so as to communicate with an engine control unit (ECU) of the vehicle. For example, the transmitter can transmit a first signal from the ECU to the passenger-side receiver, indicating that the vehicle is going to turn toward the passenger side. The passenger-side receiver receives the first signal and then accordingly generates visual indications (e.g., light rays). Similarly, the transmitter can transmit a second signal from the ECU to the driver-side receiver, indicating that the vehicle is going to turn toward the driver side. The driver-side receiver receives the second signal and accordingly generates visual indications. Embodiments with two receivers are discussed in detail with reference to FIG. 2A.

In some embodiments, the present system can include only one receiver or more than two receivers. In some embodiments, one of the receivers can function as a “relaying” device that can transmit signals or data to the other receivers. In some embodiments, there can be more than one relaying devices among multiple receivers. Embodiments of such receivers are discussed in detail with reference to FIGS. 2B and 2C.

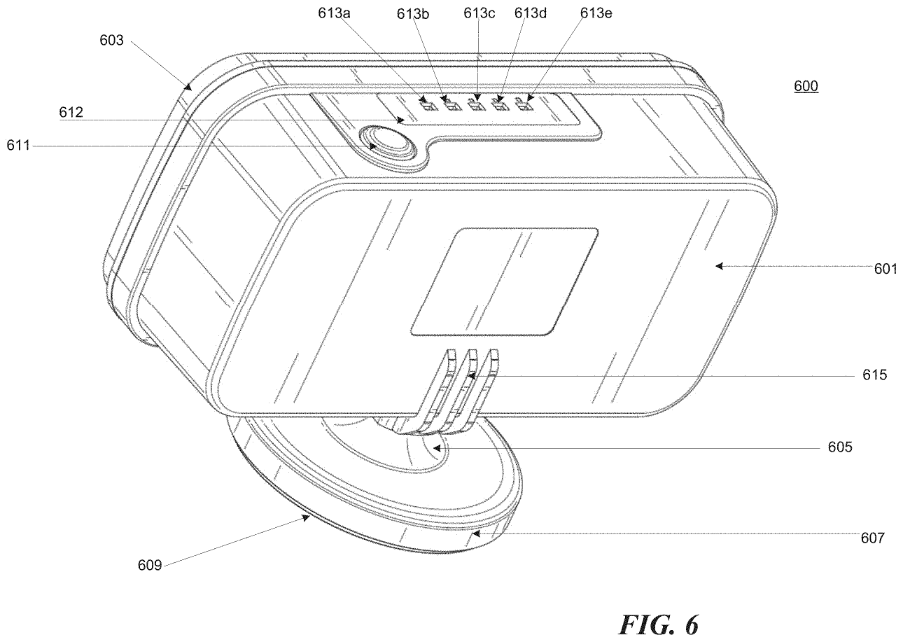

In some embodiments, the receiver can be powered by a battery. The receiver can include a battery indicator showing a status of the battery (e.g., remaining energy, battery health, etc.). In some embodiments, the battery indicator can include two or more illumination areas, and the combinations of the illumination areas are configured to show different statuses of the battery. For example, the battery indicator can include four illumination areas (e.g., first, second, third and fourth areas). When the battery is fully charged, all four illumination areas are illuminated. When the battery is at 75% battery power, the first, second, and third illumination areas are illuminated. When the battery is at 50% battery power, the first and second illumination areas are illuminated. When the battery is at 25% battery power, only the first illumination area is illuminated. In some embodiments, when the battery is at less-than-25% battery power, no illumination areas are illuminated. In other embodiments, when the battery is at less-than-25% battery power, all the illumination areas can be illuminated in a color (e.g., red) different than a “regular” illumination color (e.g., green, yellow, white, etc.). In such embodiments, the illumination areas can also blink to warn an operator that the battery is almost depleted. Embodiments of the battery indicator are discussed in detail with reference to FIG. 6 below.

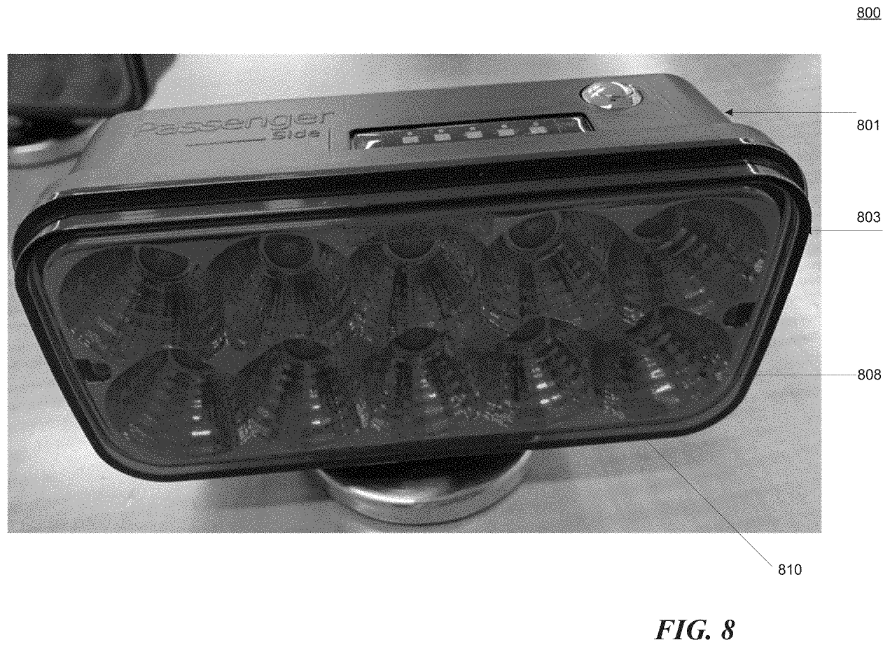

The receiver can include one or more light sockets configured to hold one or more lighting devices, respectively. In some embodiments, the receiver can include ten light sockets configured in two parallel rows, having five light sockets in each row. Each light socket has one lighting device positioned therein. In some embodiments, the lighting device can include a light emitting diode (LED), a light bulb, and/or other suitable device. Embodiments of the light sockets are discussed in detail with reference to FIG. 8 below.

One aspect of the present receiver is that the receiver can provide a constant current (or an approximately-constant current) to the one or more lighting devices, regardless of the remaining power of the battery. By this arrangement, the one or more lighting devices can emit light rays with the same or similar illumination characters (e.g., brightness, color, etc.) so as to provide stable, unchanged user experience to those who observe or view the light rays from the one or more lighting devices (e.g., a driver driving behind the vehicle carrying the receiver of the present disclosure, a pedestrian, etc.).

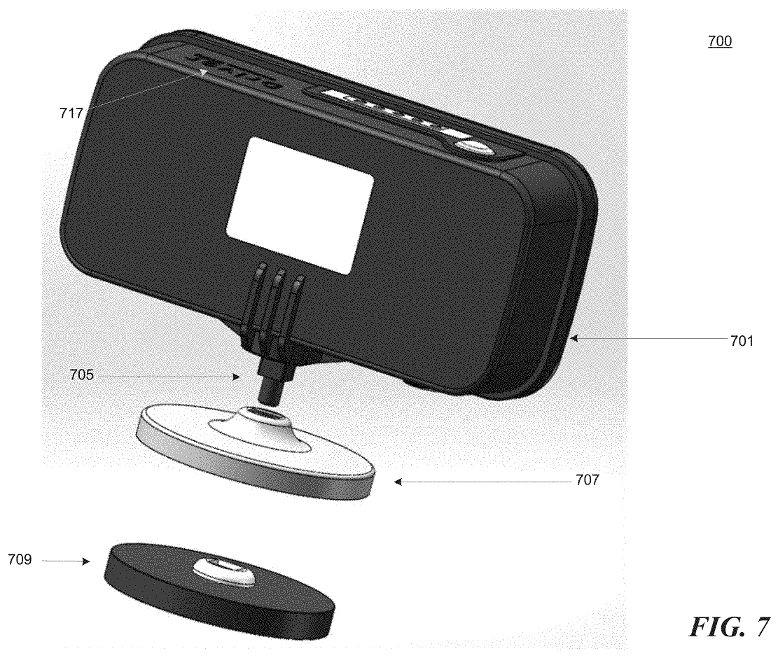

Another aspect of the present receiver is that the receiver can be easily and reliably coupled to a vehicle. In some embodiments, the receiver includes a magnetic device (e.g., a permanent magnet, an electro-magnet, etc.) configured to attach to the vehicle. By this arrangement, the receiver can be conveniently installed or removed by an operator. Embodiments of the magnetic device are discussed in detail with reference to FIG. 7 below.

In some embodiments, the present system can include more than one transmitter. For example, a first transmitter can be coupled to a vehicle, and a second transmitter can be coupled to a portable device (e.g., a smartphone operated by the driver or a passenger of the vehicle). Both of the transmitters can be configured to transmit signals to the receivers. In one example, the first transmitter can transmit a turn signal to the receiver and then the receiver can emit light rays to indicate that the vehicle is about to turn. In another example, the second transmitter can transmit a signal to the receiver showing that the vehicle to about to stop (e.g., based on the location measured by a GPS sensor in the smartphone and a predetermined destination stored in the smartphone). In this example, the receiver can emit intermittent light rays (e.g., blinking one in a second) to indicate this vehicle-stop event. The present system also enables a user to set up one or more events, pairing with one or more indication actions (e.g., the receiver emits light rays with different characters, such as color, blinking frequency, brightness, etc.).

In some embodiments, after coupling to a vehicle, the transmitter of the present system can detect whether the vehicle functions properly. For example, the transmitter can communicate with a controller (e.g., an ECU) of the vehicle and determine if there is any vehicle misfunction (e.g., an error message from the ECU) or disconnection (e.g., no response from the ECU when expecting one). If so, the transmitter can communicate with the receiver(s) of the present system to generate visual indication accordingly. By this arrangement, the present system can facilitate an operator of the vehicle to better monitor the vehicle.

In some embodiments, when the transmitter detects an event that is worth indicating (e.g., a signal from the ECU showing engine failure or a vehicle brake error), the transmitter can instruct the receivers to present such event visually and/or audibly.

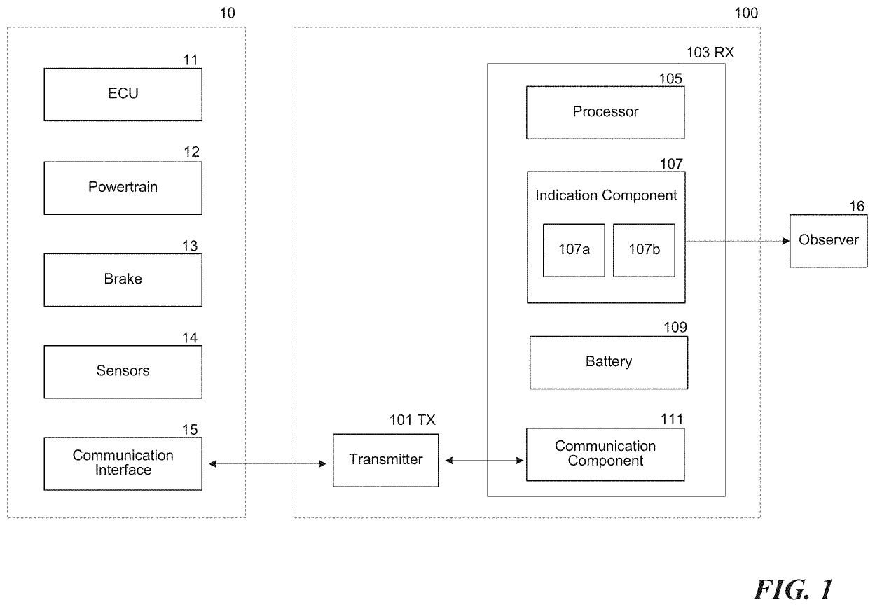

FIG. 1 is a schematic diagram illustrating a system 100 in accordance with an embodiment of the present disclosure. The system 100 is configured to receive signals from a vehicle 10 and then generate a visual indication to an observer 16. The vehicle 10 includes an ECU 11 configured to control the vehicle 10, a powertrain 12 configured to drive the vehicle 10, a brake 13 configured to stop the vehicle 10, one or more sensors 14 configured to monitor a status of the vehicle 10, and a communication interface 15 configured to communicate with a system (e.g., the system 100) or a device external to the vehicle 10. In some embodiments the communication interface 15 can include a vehicle diagnostic, scanning, and/or testing interface, such as a 7-way vehicle-end connector or a wiring adaptor.

The system 100 includes a transmitter 101 and a receiver 103. The transmitter 101 is communicably coupled to the vehicle 10 via the communication interface 15. The transmitter 101 receives a signal from the vehicle 10 and then passes the received signal to the receiver 103. The receiver 103 includes a processor 105 configured to control the receiver 103, an indication component 107 configured to generate a visual indication based on the received signal, a battery 109 configured to power the receiver 103, and a communication component 111 configured to communicate with the transmitter 101.

In response to the received signal, the indication component 107 can accordingly generate a corresponding visual indication, based on predetermined rules or configurations. For example, when the received signal includes a turn signal (e.g., vehicle 10 is about to turn), the indication component 107 can generate blinking light rays corresponding to the turn signal. As another example, when the received signal includes a brake signal (e.g., vehicle 10 is braking), the indication component 107 can generate constant light rays corresponding to the braking signal. The blinking and constant light rays can be different in color and/or brightness in various embodiments.

The indication component 107 includes one or more lighting devices 107a (e.g., an LED light bulb) and a constant-current circuit 107b configured to enable the battery 109 to provide a constant current to the indication component 107. The constant-current circuit 107b is configured to provide a constant current based on a Pulse-Width Modulation (PMW) scheme. Under the PMW scheme, the constant-current circuit 107b controls parameters such as duty ratio (or duty cycle), carrier frequency, etc.

In some embodiments, the constant-current circuit 107b can include a tail constant-current control channel and a brake constant-current control channel. The tail constant-current control channel is configured to provide a constant current to the indication component 107 when the indication component 107 generates blinking light rays. The brake constant-current control channel is configured to provide a constant current to the indication component 107 when the indication component 107 generates constant light rays. In other embodiments, the constant-current circuit 107b can have different arrangements such as having one control channel.

FIG. 2A is a schematic diagram illustrating a transmitter 101 and two receivers 103a, 103b in accordance with an embodiment of the present disclosure. In this embodiment, the transmitter 101 transmits signals to either or both of the receivers 103a, 103b. The receivers 103a, 103b can accordingly generate visual indications based on the received signals. In some embodiments, the receivers 103a, 103b can be positioned at passenger and driver sides of a vehicle, respectively.

FIG. 2B is a schematic diagram illustrating a transmitter 101 and first and second receivers 103a, 103b in accordance with an embodiment of the present disclosure. In this embodiment, the first receiver 103a can function as a signal relay device to pass on signals from the transmitter 101 to the second receiver 103b. In this embodiment, the first receiver 103a can be located at a first location closer to the transmitter 101 than a second location of the second receiver 103b.

FIG. 2C is a schematic diagram illustrating a transmitter 101 and multiple receivers 103a-n in accordance with an embodiment of the present disclosure. In this embodiment, the transmitter 101 transmits signals to one or more of the receivers 103a-n. The receivers 103a-n can accordingly generate visual indications based on the received signals, respectively. In some embodiments, one or more of the receivers 103a-n can function as a signal relay device (similar to the embodiments discussed in FIG. 2B).

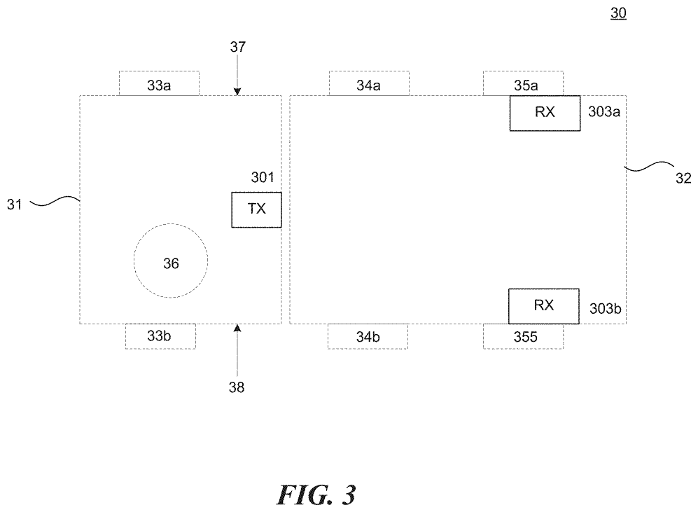

FIG. 3 is a schematic diagram (top view) illustrating a system configuration on a vehicle 30 in accordance with an embodiment of the present disclosure. As shown, the vehicle 30 includes a tractor 31 and a trailer 32 driven by the tractor 31. A driver 36 can sit in the tractor 31 to control the vehicle 30. The vehicle 30 has wheels 33a, 34a, and 35a at a passenger side 37 of the vehicle 30, and wheels 33b, 34b, and 35b at a driver side 38 of the vehicle 30. As shown, a transmitter 301 can be positioned in the tractor 31 and communicably coupled to a controller of the tractor 31. A passenger side receiver 303a can be positioned at the passenger side 37 of the trailer 32. A driver side receiver 303b can be positioned at the driver side 37 of the trailer 32. The transmitter 301 can transmit signals from the tractor 31 to the receivers 303a, 303b, and accordingly the receivers 303a, 303b can generate visual indications.

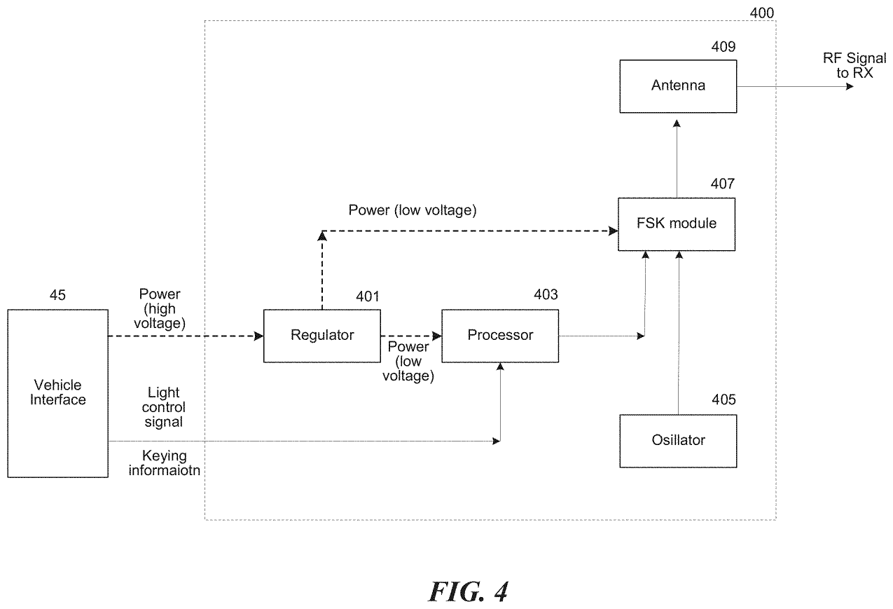

FIG. 4 is a schematic diagram illustrating a transmitter 400 in accordance with an embodiment of the present disclosure. The transmitter 400 is configured to receive a light control signal and keying information and then generate radio frequency (RF) signals that are to be transmitted to a receiver. The light control signal is generated for controlling a light of a vehicle (turn signal light, brake light, etc.) and can be processed by the transmitter 400 for further use. The keying information is for signal keying (such that a digital signal can be transmitted over an analog channel).

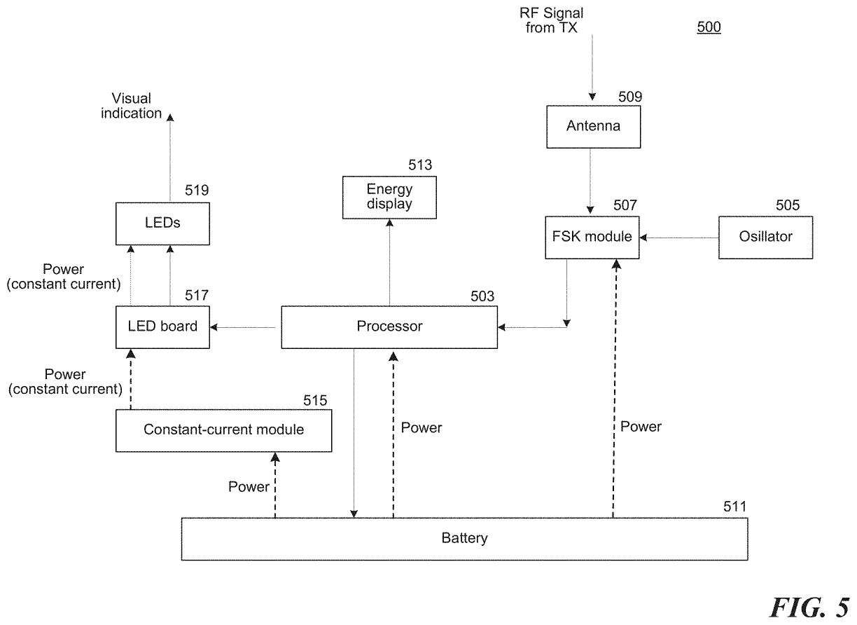

As shown in FIG. 5, a regulator 401 of the transmitter 400 is configured to adjust the voltage of an input power (e.g., 12 Volt) from a vehicle interface 45 (e.g., the communication interface 15 discussed above with reference to FIG. 1) to a lower voltage (e.g., 3 Volt, 3.3 Volt, etc.) such that the input power can be used by elements of the transmitter 400. For example, a processor 403 and a frequency shift keying (FSK) module 407 can be powered at the lower voltage.

The processor 403 of the transmitter 400 receives the light control signal and the keying information from the vehicle interface 45. Based on the keying information, the processor 403 can process the light control signal and transform it to a RF signal such that it can be transmitted by an antenna 409. The transmitter 400 also includes an oscillator 405 configured to produce a repetitive electronic signal to be used by the FSK module 407 to form the RF signal to be transmitted by the antenna 409.

FIG. 5 is a schematic diagram illustrating a receiver 500 in accordance with an embodiment of the present disclosure. The receiver 500 is configured to receive a RF signal from a transmitter (e.g., the transmitter 400) and generate a corresponding visual indication. As shown, the receiver 500 includes an antenna 509 configured to receive the RF signal. An FSK module 507 and an oscillator 505 are configured to transform the RF signal to a light control signal that can be processed (e.g., in a digital form) by a processor 503. The processor 503 can then instruct an LED board 517 to control one or more LEDs 519 to generate light rays or visual indications based on the light control signal.

The receiver 500 includes a battery 511 to provide power to the elements (e.g., the processor 503, the FSK module 507, and LEDs 519) in the receiver 500. In the illustrated embodiment, the receiver 500 includes an energy display 513 configured to indicate a status (e.g., remaining power) of the battery 511.

As shown in FIG. 5, the receiver 500 includes a constant current module 515 configured to provide a constant current to the LEDs 519. In some embodiments, the constant current module 515 can be implemented as a circuit (e.g., the constant-current circuit 107b discussed herein). The constant-current module 515 can generate the constant current based on a PMW scheme by controlling parameters such as a duty ratio and carrier frequency of the power output of the battery 511.

FIG. 6 is an isometric view of a receiver 600 in accordance with an embodiment of the present disclosure. The receiver 600 includes a housing 601 and a transparent lid 603 together form an enclosure to accommodate elements (e.g., processor, LED board, LEDs, constant-current module, etc. shown in FIG. 5) of the receiver 600. The housing 601 is coupled to a base 607 via a connector 605. The base 607 includes a magnet 609 that can be conveniently attached to a metal surface of a vehicle. The housing 601 has a protrusion 615 on its surface to enhance structure rigidity of the housing 601.

A power button 611 can be positioned on a top surface of the housing 601 and configured to turn on and off the receiver 600. In the illustrated embodiment, a battery indicator 12 can also be located on the same top surface of the housing 601. The battery indicator 12 is configured to show remaining energy of a battery of the receiver 600. As shown, the battery indicator 612 include five illumination areas, first, second, third, fourth, and fifth areas 613a-e. The illumination areas 613a-e are configured to show various levels of the remaining energy of the battery. For example, when all five areas 613-a-e are illuminated, it means that the battery is fully charged. As another example, when only the first illumination area 613a is illuminated, it means that there is around 20% remaining energy of the battery.

FIG. 7 is a partially-exploded, isometric view of a receiver 700 in accordance with an embodiment of the present disclosure. Similar to the receiver 600 in FIG. 6, the receiver 700 includes a housing 701 to a base 707 via a connector 705. The base 707 includes a magnet 709 that can be conveniently attached to a metal surface of a vehicle. The receiver 700 has a side indicator 717, indicating that the receiver 700 is a “driver-side” receiver to be installed at the driver side of a vehicle (e.g., the receiver 303b in FIG. 3). Referring to both FIGS. 6 and 7, the receiver 600 is “mirror-imaged” to the receiver 700 and therefore can be a “passenger-side” receiver (e.g., the receiver 303a in FIG. 3). Having the side indicator 717 enables an operator to quickly determine the correct side to install the receiver 700. In some embodiments, the receiver 600 in FIG. 6 can also have a side indicator.

FIG. 8 is an image showing a receiver 800 in accordance with an embodiment of the present disclosure. The receiver 800 includes a housing 801 and a transparent lid 803 attached to the housing 801. The receiver 800 includes ten (10) sockets 808 for positioning LEDs. As shown in FIG. 8, the sockets 808 are arranged in two parallel rows and are adjacent to one another. As also shown, a notch 810 is formed between two neighboring recessed sockets 808. Without wishing to be bounded by theory, the notch 810 can facilitate merging light rays from neighboring LEDs such that an overall illuminating efficiency is improved.

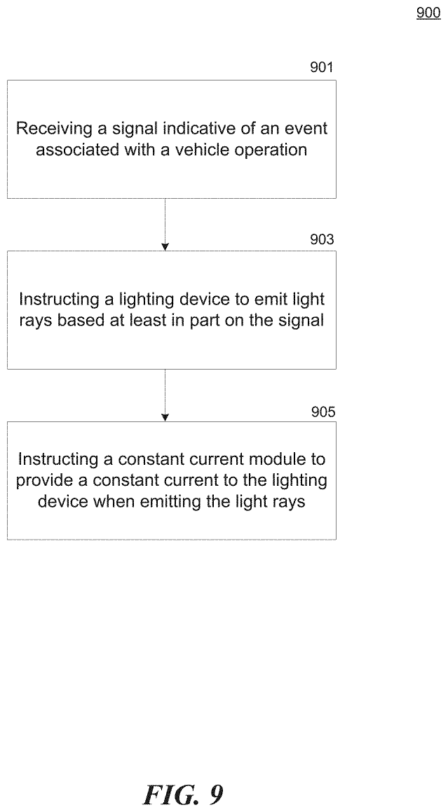

FIG. 9 is a flowchart showing a method 900 in accordance with an embodiment of the present disclosure. The method 900 is used to generate visual indications for a vehicle. The method 900 can be implemented by a system (e.g., system 100) of the present disclosure. At block 901, the method 900 includes receiving a signal indicative of an event associated with a vehicle operation. In some embodiments, the event can be a left or right turn, deacceleration, stop of the vehicle. The corresponding signals can be turn signals, brake signals, etc. In some embodiments, the signal can be received by a receiver (e.g., the receiver 103, 303, 500, 600, 700, or 800) from a transmitter (e.g., the transmitter 101, 301, or 400).

In some embodiments, the transmitter can be communicably coupled to a communication interface of a vehicle. In some embodiments, the transmitter can include a regulator configured to receive power with a first voltage and provide power with a second voltage to a processor of the transmitter and an FSK module of the transmitter. IN some embodiment, the first voltage can be about 12 Volt, and the second voltage can be about 3.3 Volt.

As block 903, the method 900 continues by instructing a lighting device to emit light rays based at least in part on the signal. In some embodiments, the lighting device can include one or more LEDs controlled by an LED board.

At block 905, the method 900 continues to instruct a constant current module to provide a constant current to the lighting device when emitting the light rays. In some embodiments, the constant current module can be a constant-current circuit (e.g., the constant-current circuit 107b discussed above). In some embodiments, the constant current circuit can include a tail constant-current control channel and a brake constant-current control channel. The tail constant-current control channel is configured to provide the constant current to lighting device indication component when the lighting device emits blinking light rays. The brake constant-current control channel is configured to provide the constant current to the lighting device when the lighting device emits constant light rays.

In some embodiments, the constant current at least partially based on a PMW scheme. In some embodiments, the method 900 can further include (1) performing the PMW scheme based on a duty ratio; and/or (2) performing the PMW scheme based on a carrier frequency. In some embodiments,

Unless contrary to physical possibility, it is envisioned that (i) the methods/steps described above may be performed in any sequence and/or in any combination, and that (ii) the components of respective embodiments may be combined in any manner.

Note that any and all of the embodiments described above can be combined with each other, except to the extent that it may be stated otherwise above or to the extent that any such embodiments might be mutually exclusive in function and/or structure.

Although the present disclosure has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

What is claimed is:

1. A method for generating a visual indication, comprising:
receiving a signal indicative of an event associated with a vehicle operation;
instructing a lighting device to emit light rays based at least in part on the signal; and
instructing a constant current module to provide a constant current to the lighting device when emitting the light rays.

2. The method of claim 1, further comprising determining the constant current at least partially based on a Pulse-Width Modulation (PMW) scheme.

3. The method of claim 2, further comprising:
performing the PMW scheme based on a duty ratio.

4. The method of claim 2, further comprising:
performing the PMW scheme based on a carrier frequency.

5. The method of claim 1, wherein the signal indicative of the event is received from a transmitter communicably coupled to a communication interface of a vehicle.

6. The method of claim 5, wherein the transmitter includes a regulator configured to receive power with a first voltage and provide power with a second voltage to a processor of the transmitter and a frequency shift keying (FSK) module of the transmitter, and wherein the first voltage is about 12 Volt, and wherein the second voltage is about 3.3 Volt.

7. The method of claim 1, wherein the constant current is determined by a constant-current circuit.

8. The method of claim 7, wherein the constant-current circuit includes a tail constant-current control channel and a brake constant-current control channel.

9. The method of claim 8, wherein the tail constant-current control channel is configured to provide the constant current to lighting device indication component when the lighting device emits blinking light rays.

10. The method of claim 8, wherein the brake constant-current control channel is configured to provide the constant current to the lighting device when the lighting device emits constant light rays.

11. A system for generating a visual indication, comprising:
a transmitter configured to be communicably coupled to a communication interface of a vehicle, the transmitter being configured to receive a signal indicative of an event associated with an operation of the vehicle;
a first receiver configured to receive a first signal from the transmitter, wherein the first signal is indicative that the operation of the vehicle is associated with a first side of the vehicle where the first receiver is located, wherein the first receiver is configured to provide a first visual indication based on the first signal, and wherein the first visual indication is provided by a first lighting device powered by a first constant current provided by a first battery in the first receiver; and
a second receiver configured to receive a second signal from the transmitter, wherein the second signal is indicative that the operation of the vehicle is associated with a second side of the vehicle where the second receiver is located.

12. The system of claim 11, wherein the second receiver is configured to provide a second visual indication based on the second signal, and wherein the second visual indication is provided by a second lighting device powered by a second constant current provided by a second battery in the second receiver.

13. The system of claim 11, wherein the vehicle includes a tractor and a trailer, and wherein the transmitter is located on the tractor, and where the first and second receiver are on the trailer.

14. The system of claim 11, wherein the first receiver is located at a driver side of the vehicle.

15. The system of claim 11, wherein the second receiver is located at a passenger side of the vehicle.

16. The system of claim 11, wherein the first receiver includes a signal relay device.

17. An apparatus for generating a visual indication, comprising:
a housing;
a transparent lip coupled to the housing, the housing and the transparent lip together forming an enclosure;
a processor in the enclosure;
one or more lighting devices, the light devices being coupled to the processor;
a battery coupled to the processor; and
a constant current module coupled to the battery and configured to provide a constant current to the one or more lighting devices.

18. The apparatus of claim 17, wherein the one or more lighting devices include one or more LEDs, and wherein each of the one or more LEDs is positioned in a socket.

19. The apparatus of claim 18, wherein the one or more LEDs are arranged in two parallel rows, and wherein a notch is formed between two neighboring LEDs.

20. The apparatus of claim 17, wherein the constant current module includes a circuit having a tail constant-current control channel and a brake constant-current control channel.
